(19) United States
(12) Patent Application Publication
(10) Pub. No.: US 2025/0338824 A1
(43) Pub. Date: Nov. 6, 2025

(54) Cat Hunt and Fish Toy

(71) Applicant: The Kyjen Company, LLC, Centennial, CO (US)

(72) Inventors: Danielle Salyer, Denver, CO (US); Jeffrey Paris, Los Angeles, CA (US); Chaz Ozzello, Englewood, CO (US)

(21) Appl. No.: 18/652,255

(22) Filed: May 1, 2024

Related U.S. Application Data
(60) Provisional application No. 63/463,308, filed on May 2, 2023.

(51) Int. Cl. A01K 15/02

(52) U.S. Cl. CPC A01K 15/025

(57) ABSTRACT

Provided is a pet toy including a base having a rounded bottom surface, a stem extending from the base, a limb diverging from the stem, and a hanging toy coupled to the limb. In some examples, the hanging toy may include a body and a cord extending from the body and coupled the limb.

This application claims the benefit of priority to U.S. Provisional Application entitled “Cat Hunt and Fish Toy,” filed May 1, 2023, and assigned Ser. No. 63/463,308, the entire disclosure of which is hereby expressly incorporated by reference.

### BACKGROUND OF THE DISCLOSURE

### Field of the Disclosure

The disclosure relates generally to pet toys, and more specifically, to interactive pet toys configured to mentally stimulate pets.

### Brief Description of Related Technology

Generally, a wide variety of pet toys are available to keep pets entertained. For example, pet toys including one or more of a squeaker, a bell, crinkle paper, and the like may be configured to make noise, entertaining pets. Other pet toys include balls, frisbees, wands, toys including treats (e.g., cat nip, pet treats), chew toys, and the like. However, pets may quickly become disinterested in their toys. Accordingly, there is a need for more dynamic and interactive pet toys that engage pets for longer periods of time.

### SUMMARY OF THE DISCLOSURE

In accordance with one aspect of the present disclosure, a pet toy includes a base having a rounded bottom surface, a stem extending from the base, a limb diverging from the stem, and a hanging toy coupled to the limb.

In accordance with another aspect of the present disclosure, a pet toy includes a base having a rounded bottom surface, a stem extending from the base, a plurality of branches diverging from the stem, and a plurality of hanging toys, one of the plurality of hanging toys being coupled to a respective one of the plurality of branches.

In accordance with yet another aspect of the present disclosure, a system includes a wobble toy having a base having a rounded bottom, a stem extending from the base, and a limb diverging from the stem and a hanging toy coupled to the limb.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates a front view of a pet toy in accordance with one example of the present disclosure.

FIG. 2 illustrates a base of a pet toy in accordance with one example of the present disclosure.

FIG. 3 illustrates a cross-section of a central structure of the pet toy of FIG. 1 in accordance with one example of the present disclosure.

FIG. 4 illustrates a cross-sectional view of a loose toy in accordance with one example of the present disclosure.

FIG. 5 illustrates a top view of a central structure of the pet toy of FIG. 1 in accordance with one example of the present disclosure.

FIG. 6 illustrates a limb part of a pet toy in accordance with one example of the present disclosure.

FIG. 7 illustrates a hanging toy in accordance with one example of the present disclosure.

FIG. 8 illustrates a hanging toy in accordance with another example of the present disclosure.

FIG. 9 illustrates a hanging toy in accordance with yet another example of the present disclosure.

FIG. 10 illustrates a hanging toy in accordance with still another example of the present disclosure.

FIG. 11 illustrates several connections between a cord of a hanging toy and a limb of a pet toy in accordance with examples of the present disclosure.

While the disclosed pet toys and methods are susceptible of embodiments in various forms, there are illustrated in the drawings (and will hereafter be described) specific embodiments of the disclosure, with the understanding that the disclosure is intended to be illustrative and is not intended to limit the disclosure to the specific embodiments described and illustrated herein.

### DETAILED DESCRIPTION OF THE DISCLOSURE

The present disclosure is provided to solve the above-mentioned problems in the Background of the Disclosure section. Specifically, the present disclosure provides a pet toy including a base having a rounded bottom surface, a stem extending from the base, a limb extending or diverging from the stem, and a hanging toy coupled to the limb.

A pet toy according to the present disclosure may be configured to wobble (e.g., sway, rock, teeter, oscillate) when a pet or human contacts the toy, applying a force to the toy. Specifically, the toy may be configured to move or wobble (e.g., sway, rock, teeter, oscillate) about the rounded bottom of the base. As the toy moves or wobbles, an area or portion of the rounded bottom surface in contact with the surface supporting the toy may change. According to some examples, the toy may be configured to move or wobble back and forth about a center of the rounded bottom surface of the base. For example, a center of gravity or balance point of the pet toy may be disposed above the center of the rounded bottom surface, such that when a pet or user does not apply a force to the pet toy, the pet toy balances about the center of the bottom surface.

A pet toy according to the present disclosure may further include a stem extending from the base, a limb diverging from the stem, and a hanging toy coupled to or hanging from the limb. According to some examples, the pet toy may include two or more (e.g., a plurality of) limbs and two or more (e.g., a plurality of) hanging toys. For example, a hanging toy may be coupled to or hang from a respective limb of the plurality of limbs. The stem, limbs, and hanging toys may encourage a pet, for example, a cat, to interact or play with the pet toy. Further, when a pet plays with the pet toy, contacting the stem, a limb, or a hanging toy, the pet toy may move or wobble about the bottom surface of the base. According to some examples, as described below in greater detail, a hanging toy according to the present disclosure may include one or more of cat nip, bright colors, distinct or contrasting colors or images, distinct textures, and contrasting textures to attract or capture the attention of a pet.

According to some examples, the base of the pet toy may be a bowl including an inner surface defining a cavity and the pet toy may further include a loose toy disposed in the cavity of the bowl. According to the present disclosure the term “loose toy” may refer to a toy that is unrestrained within the cavity. In one example, the loose toy may include a noisemaker configured to make or produce noise as the loose toy moves. Accordingly, as a pet interacts with a pet toy according to the present disclosure, contacting the pet toy and causing it to move or wobble, the loose toy may move within the cavity of the bowl making or producing a noise. According to some examples, the bowl may include a panel including one or more apertures configured to receive the loose toy disposed above the cavity. The panel may be configured to maintain a position of the loose toy within the cavity when a pet or human interacts with the pet toy causing it to move or wobble.

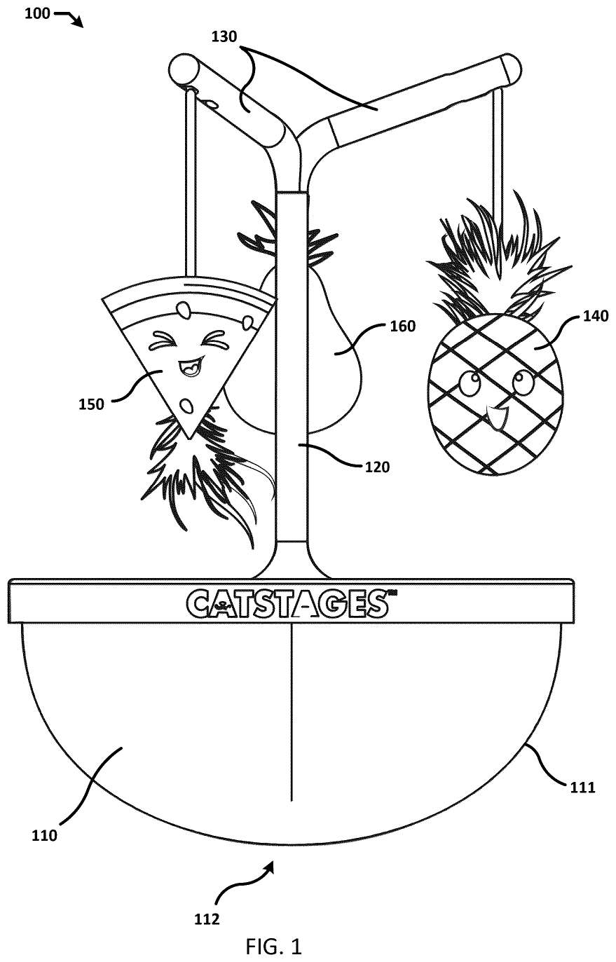

Referring to FIG. 1, a wobble toy or pet toy 100 is illustrated in accordance with one example of the present disclosure. As shown in FIG. 1, the pet toy 100 may include a base 110, a stem 120 extending from the base 110, at least one limb 130 extending from the stem 120, and at least one hanging toy 140, 150, or 160, each hanging toy 140, 150, or 160 coupled to one of the limb(s) 130. In some examples, the pet toy 100 may include a corresponding number of limbs 130 and hanging toys 140, 150, 160. For example, each hanging toy 140, 150, 160 may be coupled to a respective one of the limbs 130. According to some examples, as illustrated in FIG. 1, the pet toy 100 may include three limbs 130 and three hanging toys 140, 150, 160; however, the present disclosure is not limited thereto. For example, the pet toy 100 may include one, two, four, or five or more limbs 130 and/or hanging toys 140, 150, 160.

The base 110 may be configured to support the stem 120, limbs 130, and hanging toys 140, 150, 160 of the pet toy 100. Specifically, the base 110 of the of the pet toy 100 may contact or rest on a surface supporting the pet toy 100. According to some examples, the base 110 may include a curved or rounded bottom surface 111 configured to contact a surface supporting the pet toy 100. In some examples, as illustrated in FIG. 1, the rounded bottom surface 111 may be smooth or even and including a single continuous or coextensive face. As noted above, the pet toy 100 may be configured to move or wobble (e.g., sway, rock, teeter, oscillate) about the rounded bottom surface 111 of the pet toy 100 when a pet or human interacts with the pet toy 100 by contacting the pet toy 100 or otherwise applying a force to the pet toy 100. An area or portion of the rounded bottom surface 111 contacting a surface supporting the base 110 may change as the pet toy moves or wobbles.

The shape of the base 110 may vary. In some examples, as illustrated in FIG. 1, the base 110 may have a hemisphere shape. In other examples, the base 110 may have a shape corresponding to another portion of a sphere. For example, the base 110 may be sphere shaped or have the shape of a spherical cap (e.g., smaller or larger than hemisphere of the same sphere). In other examples, the base 110 may have an ellipsoid shape, a hemi-ellipsoid shape (about either axis of symmetry), or the shape of an ellipsoid cap (e.g., smaller or larger than the hemi-ellipsoid and taken about either axis of symmetry). In other examples, the base 110 may have an ovoid shape or a shape corresponding to any portion of an ovoid (e.g., a solid defined by cutting an ovoid with a plane). The base 110 may be any shape including a rounded surface.

According to some examples, a center of gravity or balance point of the pet toy 100 may be disposed above a center 112 of the rounded bottom surface 111. In these examples, when the pet toy 100 is in equilibrium, the pet toy 100 may sit upright or vertically on the center 112 of the rounded bottom surface 111, for example, as illustrated in FIG. 1. Further, when the center of gravity of the pet toy 100 is disposed above the center 112 of the rounded bottom surface 111, the pet toy 100 may be configured to move or wobble about the center 112 of the rounded bottom surface 111. For example, when a lateral force is applied to the pet toy 100 by a pet or human, the pet toy 100 may be configured to wobble (e.g., sway, rock, teeter, oscillate) back and forth about the center 112 of the rounded bottom surface 111. Specifically, in these examples, at a midpoint or center of the back and forth or oscillating, wobbling motion of the pet toy, the center 112 of the rounded bottom surface 111 may contact the surface supporting the pet toy 100 and the pet toy 100 may be disposed in an upright position, for example, as illustrated in FIG. 1. The pet toy 100 will eventually return to an equilibrium position as energy (e.g., kinetic, gravitational potential) of the pet toy 100 dissipates.

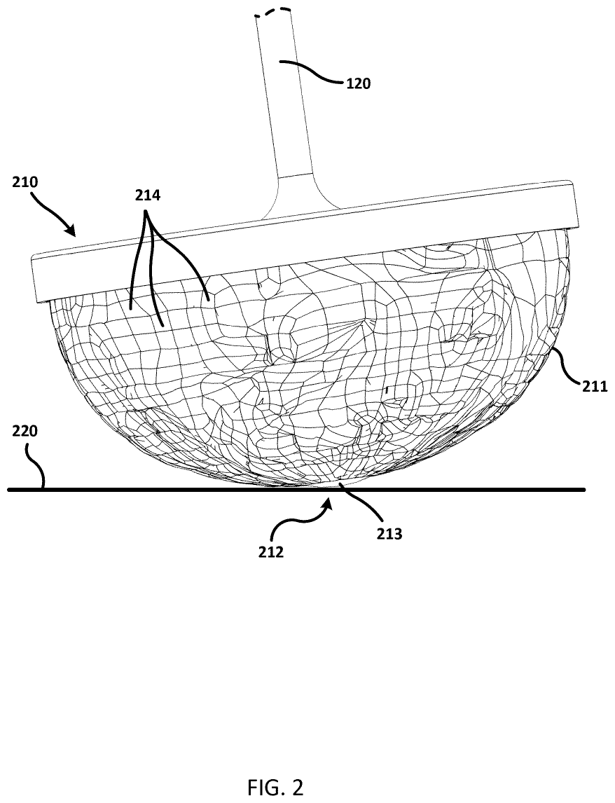

Referring to FIG. 2, a base 210 of a pet toy, for example, the pet toy 100 illustrated in FIG. 1, is illustrated in accordance with one example of the present disclosure. In some examples, a rounded bottom surface 211 of the base 210 may be textured or uneven. For example, as illustrated in FIG. 2, the rounded bottom surface 211 may include a plurality of convex protrusions 214, such that the rounded bottom surface 211 is irregular or textured. The plurality of convex protrusions 214 of the rounded bottom surface 211 may be configured to contact a surface 220 (e.g., ground or floor) supporting the base 210 (and a pet toy including the base). Specifically, the base 210 may be supported by or on an apex or tip of multiple (e.g., three or more) of the plurality of convex protrusions 214. Accordingly, when a force is applied to a pet toy including the base 210, the pet toy may move or wobble about the plurality of convex protrusions 214. Specifically, different (e.g., a different set of three or more) convex protrusions 214 may support the base 210 as the pet toy moves or wobbles. According to some examples, when a force is applied, for example, by a pet or human to a pet toy including a textured, rounded bottom surface 211 including a plurality of convex protrusions 214, the pet toy may move or wobble (e.g., sway, rock, teeter, oscillate) back and forth along a non-linear or unpredictable pathway. Specifically, a wobbling motion of the pet toy including a textured, rounded bottom surface 211 including a plurality of convex protrusions 214 may depend on a quantity, size, and/or pattern (e.g., regular pattern, irregular pattern) of the plurality of convex protrusions 214 included in the rounded bottom surface 211. In another example, the rounded bottom surface 211 may include a textured pattern resembling a woven basket (i.e., multiple horizontal strands and vertical strands, resulting in a square pattern associated with woven baskets). In this case, the areas representing where the individual strands overlap creates an irregular surface pattern, which also results in a non-linear or unpredictable wobble path.

Still referring to FIG. 2, in some examples, the base 210 may further include a hub 213 extending or protruding from the center 212 of the rounded bottom surface 211. In these examples, a pet toy including the base 210 in an equilibrium or balanced position may be supported by the hub 213 and two or more of the plurality of convex protrusions 214. For example, when a pet toy including the base 210 is in equilibrium, the pet toy may be supported by the hub 213 and two or more of the plurality of convex protrusions 214, so as to be disposed at an angle with respect to a vertical axis (e.g., an axis perpendicular to the supporting surface 220).

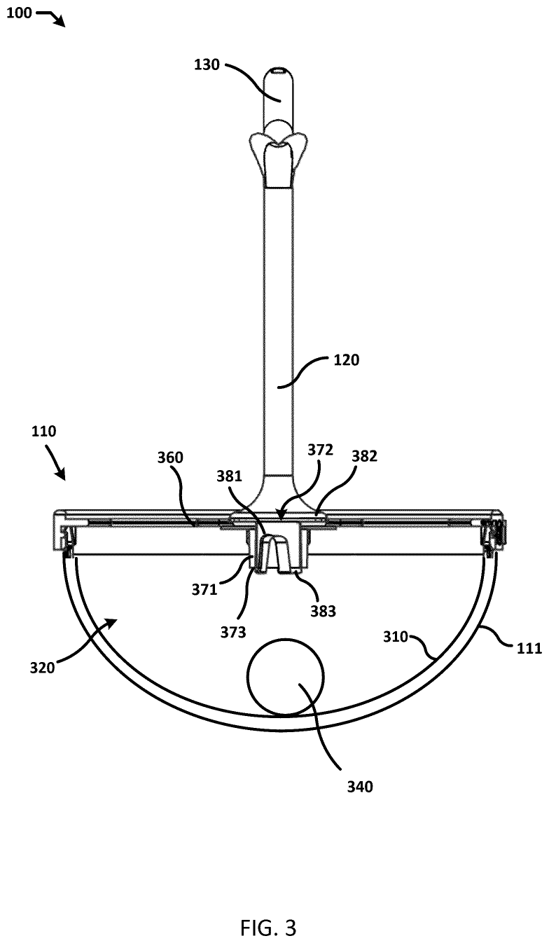

Referring to FIG. 3, a cross-sectional view of a central structure of the pet toy 100 of FIG. 1 is illustrated in accordance with one example of the present disclosure. The central structure of the pet toy 100 may include the base 110, the stem 120, and the limbs 130 of the pet toy 100. According to some examples, as illustrated in FIG. 3, the base 110 may have a bowl or basin shape including an inner surface 310 defining a cavity 320 within the base 110. The size and/or shape of the cavity 320, as defined by the inner surface 310 of the base 110 may vary. In some examples, the inner surface 310 may be rounded, such that the cavity 320 has a rounded bottom (e.g., bottom wall). The shape of the inner surface 310 may correspond or be substantially similar to the shape of the rounded bottom surface 111 of the base 110. A shape of the cavity 320 may correspond to a shape of the base 110. For example, a base 110 having a hemisphere shape may include a cavity 320 having a hemisphere shape, for example, as illustrated in FIG. 3.

In some examples, the pet toy 100 may further include an internal or loose toy 340. The loose toy 340 may be disposed within the cavity 320 of the base 110. The loose toy 340 may be unrestrained or free to move within the cavity 320 of the base 110. The loose toy 340 may be configured to move within the cavity 320 as the pet toy 100 moves or wobbles. For example, when a pet or human interacts with the pet toy 100, contacting the pet toy 100 or otherwise exerting a force on the pet toy 100, a force may also be asserted on the loose toy 340 (e.g., via the base 110) causing the loose toy 340 to move within the cavity 320.

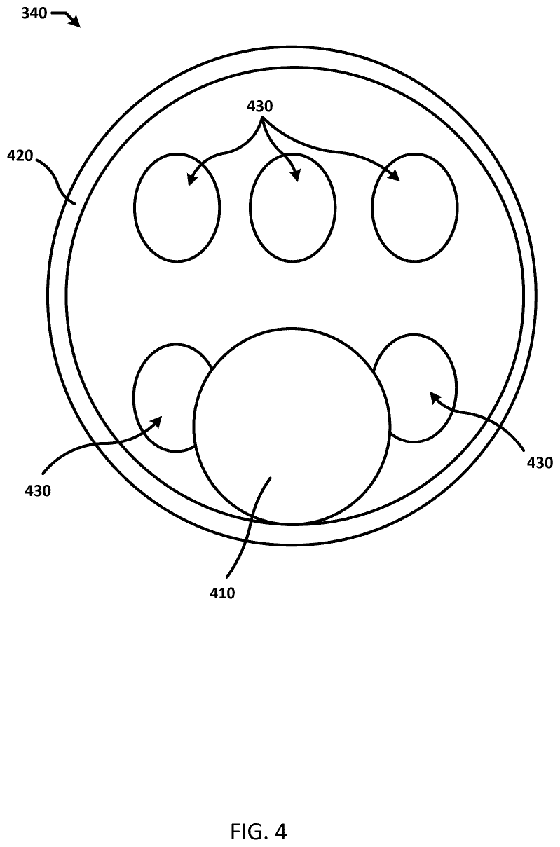

Referring to FIG. 4, a cross-sectional view of a loose toy 340 is illustrated in accordance with one example of the present disclosure. Referring generally to FIGS. 3 and 4, the loose toy 340 may have a round shape. For example, as illustrated in FIG. 3, the loose toy 340 may have a spherical shape. However, the present disclosure is not limited thereto and in other examples, the loose toy 340 may have an ellipsoidal, ovoidal, or any other round shape. In these examples, the round shape of the loose toy 340 may facilitate movement of the loose toy 340 within the cavity 320. For example, the round shape of the loose toy 340 may increase a duration of time during which the loose toy 340 moves within the cavity 320 after a force is applied to the pet toy 100 (e.g., as compared to a loose toy 340 having planar side and/or a non-spherical shape).

According to some examples, as illustrated in FIG. 4, the loose toy 340 may include a noisemaker 410. For example, the loose toy 340 may include a spherical, ellipsoidal, ovoidal, or other shaped outer surface or shell 420 and include a noisemaker 410 disposed within the outer surface or shell 420. In some examples, the outer surface or shell 420 may include one or more holes 430, such that sound generated by the noisemaker 410 may travel out of outer surface or shell 420 of the loose toy 340. The noisemaker 410 may be configured to make or produce a noise as the loose toy 340 moves within a base 110, 210 of a pet toy 100. For example, the noisemaker 410 may be configured to make a noise as the noisemaker 410 is moved, compressed, or deformed (e.g., as momentum of a noisemaker 410 dissipates as the noisemaker contacts the shell 420 of the loose toy 340) within the loose toy 340 and/or base of the pet toy. The noisemaker 410 may any of a bell, a rattle, crinkle paper, a clicker, a whistle, a squeaker, an electronic noise producing device, or the like, and any combinations thereof.

According to some examples, the loose toy 340 may have a plush exterior. According to some examples, the loose toy 340 may include a light element configured to emit light when the loose toy 340 moves within the base of a pet toy. In some examples, the light element may be configured to emit a flashing or blinking light. For example, the light element may emit light in a plurality of pulses having regular or irregular durations at a plurality of regular or irregular intervals. In some examples, the loose toy 340 may include any combination of two or more of a noisemaker, a plush exterior, or a light element. In some examples, a base of the pet toy, for example, the base 110, may include a plurality of openings or windows, such that the loose toy 340 and/or light emitted by the loose toy 340 may be visible from outside of the base. The openings or windows may be smaller than the loose toy 340, such that the loose toy 340 cannot pass through the openings or windows to an exterior of the base. According to some examples, as illustrated in FIG. 3, the pet toy 100 may include a single loose toy 340. In other examples, the pet toy 100 may include two or more loose toys 340.

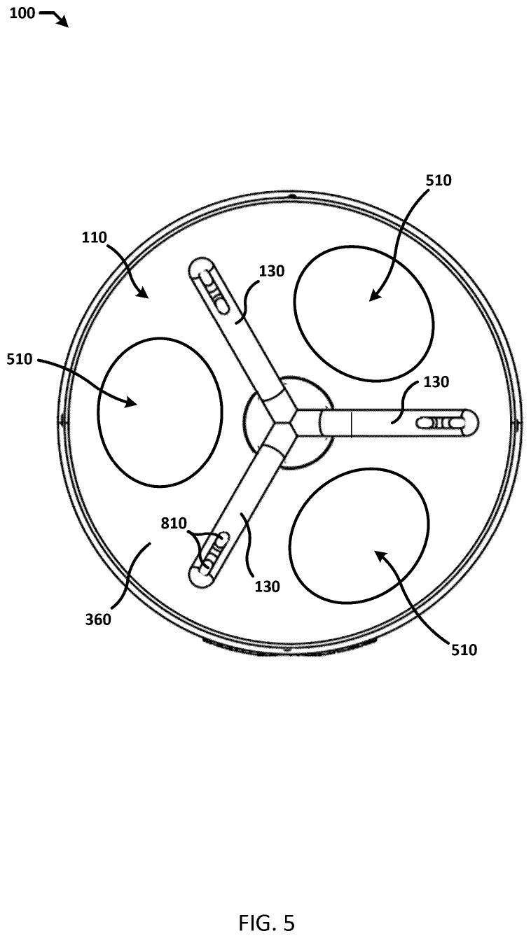

Referring generally to FIGS. 3 and 5, in some examples, the base 110 may further include a panel 360 disposed above the cavity 320 of the base 110. In some examples, as illustrated in FIGS. 3 and 5, the panel 360 may have a flat or planar shape. However, the present disclosure is not limited thereto and in other examples, the panel 360 may have a curved, concave or convex shape. In some examples, the panel may define a top surface of the base 110. The panel 360 may be configured to maintain a position of the loose toy 340 within the cavity 320 as a pet or human interacts or plays with the pet toy 100 moving the pet toy 100, and thus, causing the pet toy 100 to move or wobble. Referring to FIG. 5, the panel 360 may include one or more (e.g., a plurality of) apertures 510 extending therethrough. According to some examples, as illustrated in FIG. 5, the panel 360 may include three apertures 510; however, the present disclosure is not limited thereto. For example, the panel 360 may include one, two, four, or five or more apertures 510. The apertures 510 may be larger than the loose toy 340 and configured to receive the loose toy 340, such that the loose toy 340 may be placed into or removed from the cavity 320 of the base 110.

Returning to FIG. 3, the pet toy 100 may further include a stem 120 extending from the base 110. In some examples, as illustrated in FIG. 3, the stem 120 may extend or protrude from a top surface of the base 110. The stem 120 may include a proximal end disposed at or coupled to the base 110 and a distal end opposite the proximal end. In some examples, as illustrated in FIG. 3, the stem 120 may be disposed perpendicular to the top surface of the base 110. In some examples, as illustrated in FIG. 3, the stem 120 may extend or protrude from a panel 360 of the base 110.

In some examples, as illustrated in FIG. 3, the stem 120 may be attached or coupled to the base 110. In other examples, the stem 120 may be integrally formed with one or more components, for example, the panel 360 of the base 110. In some examples, the base 110 may include a hollow channel 371 including an interior 372 (shown as occupied by the stem 120 in FIG. 3) configured to receive a coupling protrusion 381 of the stem 120. Further, a first or bottom end of the stem 120 may include a flange 382 configured to contact a top surface of the base 110 (e.g., a top surface of the panel 360). The first or bottom end of the stem 120 may also include a coupling protrusion 381 extending from the flange 382, the coupling protrusion 381 configured to be inserted through the hollow channel 371. The coupling protrusion 381 may include at least one barb 383. When the stem 120 is coupled to the base 110, the barb 383 may be inserted through the interior 372 of the hollow channel 371. After passing through the hollow channel 371 the barb 383 may engage (e.g., abut, contact) a bottom surface 373 of the hollow channel 371, such that the coupling protrusion 381 may not be withdrawn from the hollow channel 371 without deforming the coupling protrusion 381, the barb 383, or the hollow channel 371.

In other examples, the stem 120 and base 110 may be coupled to one another in other ways. For example, an adhesive or glue, one or more fasteners (e.g., screws, rivets), plastic welding, and the like, or any combination thereof may be used to couple the stem 120 and base 110 to one another. In another example, the stem 120 may be removably coupled to the base 110. For instance, the stem 120 and base 110 may have a press fit, friction fit, or other interference fit connection. The stem 120 may also be snap fit into the base 110. These types of removable connections allow for other features to be interchanged with the stem 120, thus providing modularity and variety to the pet toy 100.

Referring generally to FIGS. 1 and 5, the pet toy 100 may further include a branch or limb 130 extending (e.g., diverging, branching) from the stem 120. The limb 130 may extend radially outward from the stem 120. In some examples, the limb 130 may extend from a distal end of the stem 120. In another example, the limb 130 may extend from a midpoint of the stem 120, about halfway between the distal and proximal ends of the stem 120. The limb 130 may have a proximal end disposed at or coupled to the stem 120 and a distal end opposite the proximal end. In some examples, as illustrated in FIG. 1, the pet toy 100 may include three limbs 130. However, the present disclosure is not limited thereto. For example, the pet toy 100 may include one, two, four or more than four limbs 130.

In some examples, the one or more limbs 130 may be integrally formed with the stem 120. In other examples, the one or more limbs 130 may be formed separately from and subsequently (e.g., removably) coupled to the stem 120. For example, the one or more limbs 130 may be coupled to the stem 120 using a press or interference fit, an adhesive or glue, plastic welding, one or more fasteners, or the like, or any combination thereof. In some examples, some (e.g., at least one of) the limbs 130 may be integrally formed with stem 120 and some (e.g., at least one of) the limbs 130 may be formed separately from and subsequently (e.g., removably) coupled to the stem 120.

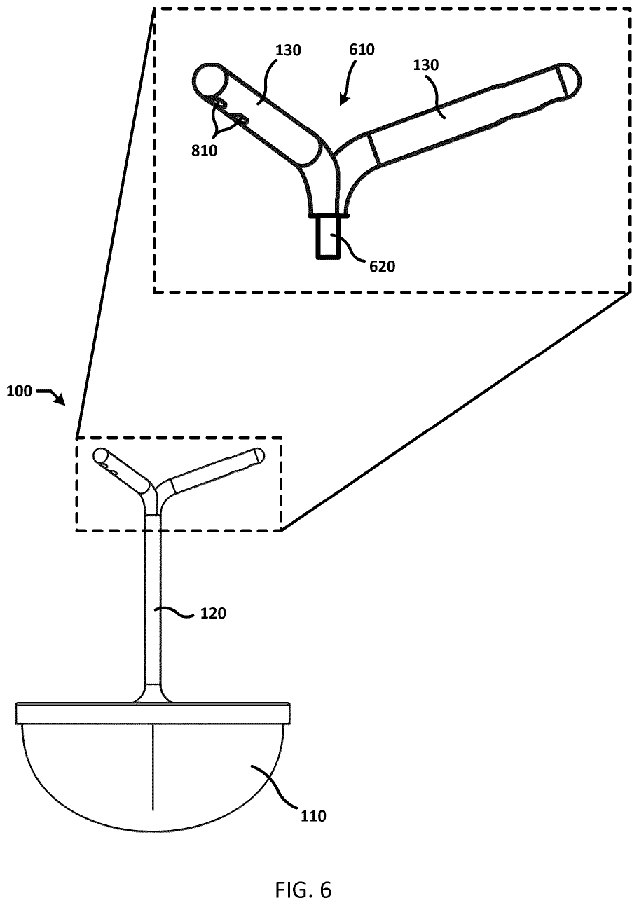

Referring to FIG. 6, in some examples, two or more limbs 130 may be integrally formed together and subsequently coupled to the stem 120. Specifically, as shown in FIG. 6, in some examples, the pet toy 100 may include a branch part 610 including a plurality of limbs 130. The branch part 610 may be coupled to the distal end of the stem 120. In some examples, as illustrated in FIG. 6, the branch part 610 may include a tapered end 620 configured to be inserted into a socket in the stem 120, coupling the branch part 610 to the stem 120. In some examples, the tapered portion 620 and the socket included in the stem 120 may have the same shape such that an interference or press fit (e.g., tolerance stacking) may be used to couple the branch part 610 to the stem 120. However, the present disclosure is not limited thereto; any of a press or interference fit, an adhesive or glue, plastic welding, one or more fasteners, or the like, or any combination thereof may be used to couple the branch part 610 to the stem 120. In some examples, the branch part 610 may be removably coupled to the stem 120, such that the branch part 610 may be replaced with other branch parts or features, thereby providing interchangeability and variety to the pet toy 100.

Returning to FIG. 1, the pet toy 100 may further include one or more hanging toys 140, 150, 160. As noted above, in some examples, the pet toy 100 may include a corresponding number of limbs 130 and hanging toys 140, 150, 160. For example, each hanging toy 140, 150, 160 may be coupled to a respective one of the limbs 130. However, the present disclosure is not limited thereto and the pet toy 100 may include any number of hanging toys 140, 150, 160. In some examples, two or more hanging toys 140, 150, 160 may be coupled to one of the limbs 130.

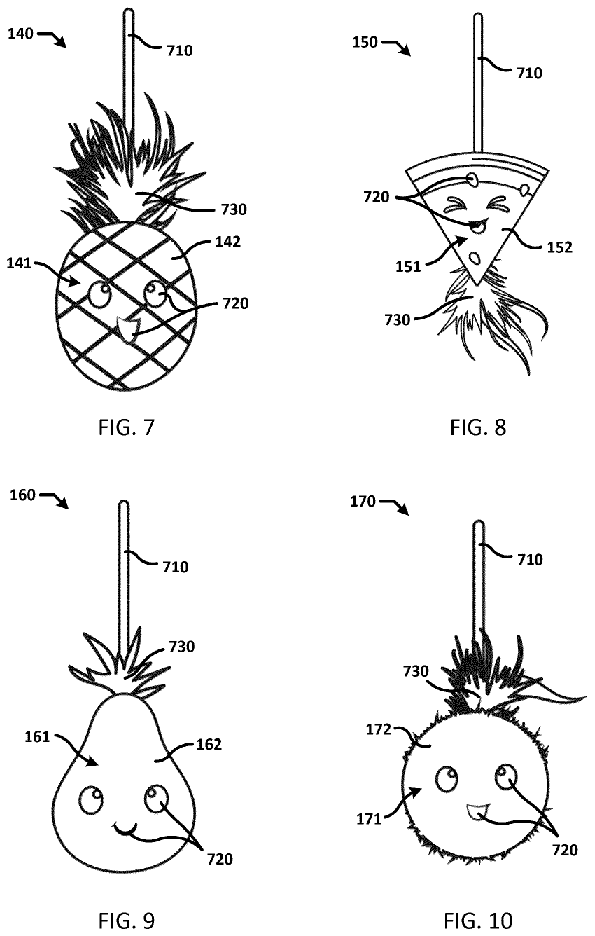

Referring generally to FIGS. 7-10, several hanging toys 140, 150, 160, and 170, respectively, are illustrated in accordance with examples of the present disclosure. The pet toy 100 may include any combination of the hanging toys 140, 150, 160, 170. Referring generally to FIGS. 7-10, each of the hanging toys 140, 150, 160, 170 may include a cord 710 and a body 141, 151, 161, 171. The cord 710 may be coupled to and/or extend from the body 141, 151, 161, 171 and be configured to couple the respective hanging toy 140, 150, 160, 170 to a limb 130 of the pet toy 100. The cord 710 may support a respective body 141, 151, 161, 171, such that the body 141, 151, 161, 171 hangs from a limb 130 of the pet toy 100. In some examples, the cord 710 may be comprised of an elastic material.

Still referring to FIGS. 7-10, the bodies 141, 151, 161, 171 may each include a case or cover 142, 152, 162, 172, respectively, and an internal compartment. The cover 142, 152, 162, 172 may define an outer surface of the hanging toy. The cover 142, 152, 162, 172 may be comprised of a plush textile. In some examples, the cover 142, 152, 162, 172 may be comprised of a plush textile having pile (e.g., a plurality of loops or strands) extending from the base textile. The cover 142, 152, 162, 172 may be comprised of a polyester plush textile or fabric.

The internal compartment may be disposed within the cover 142, 152, 162, 172 of the respective body 141, 151, 161, 171. The internal compartment of each body 141, 151, 161, 171 may be stuffed with a filler material. The filler material may give the body 141, 151, 161, 171 a voluminous, three-dimensional shape. In some examples, the filler material may be comprised of polyester or another synthetic textile. In some examples, the filler material may include catnip in order to attract or capture the attention of a pet. Filler material including cat nip may encourage a pet to engage or play with the hanging toy 140, 150, 160, 170, for example, batting or otherwise contacting the hanging toy 140, 150, 160, 170 and causing the pet toy 100 to move or wobble about the base 110.

As illustrated in FIGS. 7-10, bodies 141, 151, 161, 171 may have various shapes. In some examples, as illustrated in FIGS. 7-10, the bodies 141, 151, 161, 171 may be shaped to represent fruit. Specifically, the body 141 may be shaped to represent a pineapple, the body 151 may be shaped to represent a slice of watermelon, the body 161 may be shaped to represent a pear, and the body 171 may be shaped to represent an orange. The bodies 141, 151, 161, 171 may be shaped to represent or have the shape of any item, object, or living thing. In some examples, the bodies 141, 151, 161, 171 may further include one or more designs or images printed and/or embroidered on the cover 142, 152, 162, 172 of the bodies 141, 151, 161, 171, some of which are discussed below. In some examples, as illustrated in FIG. 7-10, the hanging toys 140, 150, 160, 170 may further include one or more decorative elements 720. The decorative elements 720 may be coupled to the cover 142, 152, 162, 172 of the hanging toy 140, 150, 160, 170. The decorative element 720 may be, for example, a design printed or embroidered on the cover 142, 152, 162, 172. For example, a facial feature or features (e.g., eyes, nose, ears, mouth, eyebrows, or the like) may be printed or embroidered on the cover 142, 152, 162, 172. In some examples, the hanging toy 140, 150, 160, 170 may further include an attractant 730, for example, a tuft or feather coupled to the cover 142, 152, 162, 172 of the body 141, 151, 161, 171.

One or more decorative 720 elements and/or attractants 730 may be sewn, glued, or otherwise coupled to the cover 142, 152, 162, 172 of the hanging toys 140, 150, 160, 170. The decorative elements 720 and/or attractants 730 may be comprised of a different material, have a different color, and/or have a different texture than the cover 142, 152, 162, 172. Specifically, in some examples, the cover 142, 152, 162, 172 and the decorative element 720 may have different textures, so as to attract a pet. In some examples, a textile or fabric of which the cover 142, 152, 162, 172 is made and a textile or fabric of which the decorative element 720 is made may include pile or strands having different lengths. In other examples, the cover 142, 152, 162, 172 and the decorative element 720 or attractant 730 may have contrasting colors, so as to attract a pet.

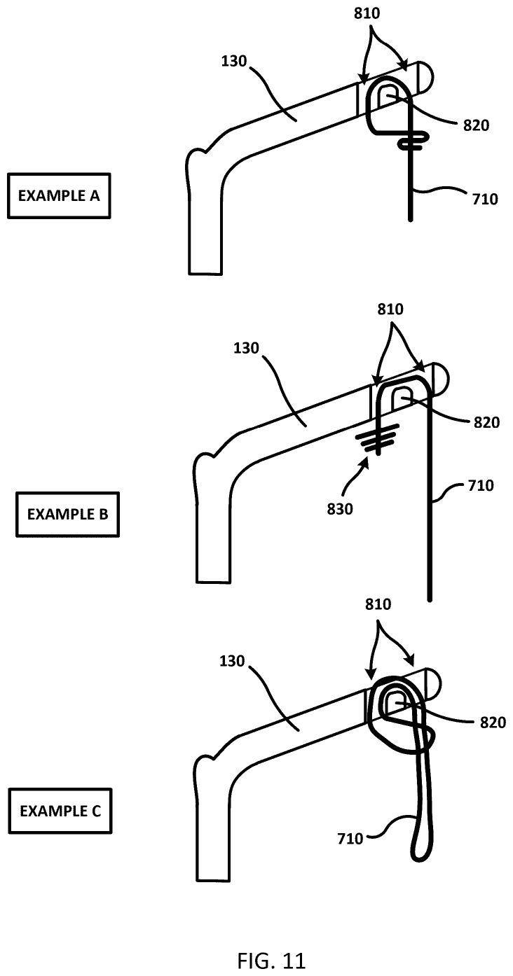

Referring to FIG. 11, several connections between the cord 710 of a hanging toy 140, 150, 160, 170 and a limb 130 are illustrated in accordance with examples of the present disclosure. Referring generally to FIGS. 5, 6, and 11, each limb 130 may include one or more openings 810 configured to receive a cord 710 for coupling a hanging toy, for example, one of the hanging toys 140, 150, 160, 170, illustrated in FIGS. 7-10, respectively, to the limb 130. Further, in some examples, as best shown in FIG. 8, when the limb 130 includes two or more openings 810 the limb 130 may further include a post 820 disposed between the openings 810.

In a first example, Example A, as illustrated in FIG. 11, the cord 710 may be inserted through a first one of the openings 810, wrapped around the post 820, inserted through a second one of the openings 810 and tied around a portion of itself that has not been inserted through the openings 810 of the limb 130.

In a second example, Example B, as illustrated in FIG. 11, the cord 710 may be inserted through a first one of the openings 810, wrapped around the post 820, inserted through a second one of the openings 810 and a knot 830 may be tied at an end of the cord 710 that has been inserted through the first and second openings 810 of the limb 130. Specifically, a knot 830 larger than an area of the first and/or second opening 810 may be tied at an end of the cord inserted through the first and second openings 810, such that the cord 710 may be withdrawn through the first and/or second openings 810.

In a third example, Example C, as illustrated in FIG. 11, the cord 710 may form a closed loop. In this example, a first side of loop may be inserted through a first one of the openings 810, wrapped around the post 820, and inserted through a second one of the openings 810 and a second side of the loop, not having traveled through the first or second openings 810, may be pulled through the first side of the loop having traveled through the first and second openings 810 of the limb 130.

It should be understood that, although the terms first, second, etc. may be used herein to describe various elements, components, regions, levels, layers, and/or sections, these elements, components, regions, levels, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

For clarity of disclosure, the terms “proximal” and “distal” are defined herein relative to a center of the pet toy 100 and/or a point of attachment of an element of the present disclosure. The term “proximal” refers to the position of an element closer to the center of the pet toy 100 or a point of attachment. The term “distal” refers to the position of an element further away from the center of the pet toy 100 or a point of attachment. Also for clarity of disclosure, the terms “top,” “upper,” “bottom,” and “lower” are defined herein relative to a position of the base of the pet toy resting on a horizontal surface, such as the ground or floor. The terms “top” and “upper” refer to the position of an element further away from the horizontal surface. The terms “bottom” and “lower” refer to the position of an element closer to the horizontal surface.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

While the present disclosure has been described with reference to specific examples, which are intended to be illustrative only and not to be limiting of the disclosure, it should be apparent to those of ordinary skill in the art that changes, additions and/or deletions may be made to the disclosed embodiments without departing from the spirit and scope of the disclosure.

The foregoing description is given for clarity of understanding only, and no unnecessary limitations should be understood therefrom, as modifications within the scope of the disclosure may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

1. A pet toy comprising:
a base having a rounded bottom surface;
a stem extending from the base;
a limb diverging from the stem; and
a hanging toy coupled to the limb,
wherein the rounded bottom surface includes a plurality of convex protrusions configured to contact a surface supporting the base.

2. The pet toy of claim 1, wherein the hanging toy includes:
a body; and
a cord extending from the body and coupled the limb.

3. The pet toy of claim 2, wherein the body includes:
a cover;
a compartment within the cover; and
a filler material disposed within the compartment.

4. The pet toy of claim 3, wherein the filler material includes catnip.

5. The pet toy of claim 2, wherein the cord is comprised of an elastic material.

6. The pet toy of claim 1, wherein the base is a bowl including an inner surface defining a cavity.

7. The pet toy of claim 6, further comprising:
a loose toy disposed within the cavity of the bowl.

8. The pet toy of claim 7, wherein the loose toy includes a noisemaker.

9. The pet toy of claim 7, wherein:
the bowl includes a panel disposed above the cavity;
the stem is coupled to and extends from the panel; and
the panel includes an aperture configured to receive the loose toy.

10. The pet toy of claim 6, wherein the bowl includes a weight disposed at a bottom/center of the cavity.

11. The pet toy of claim 1, wherein the plurality of convex protrusions are configured to cause the pet toy to wobble back and forth along a non-linear pathway.

12. A pet toy comprising:
a base having a rounded bottom surface;
a stem extending from the base;
a plurality of branches diverging from the stem; and
a plurality of hanging toys, one of the plurality of hanging toys being coupled to a respective one of the plurality of branches,
wherein the rounded bottom surface includes a plurality of convex protrusions configured to contact a surface supporting the base.

13. The pet toy of claim 12, wherein each hanging toy of the plurality of hanging toys includes:
a body including a compartment;
a filler material disposed within the compartment; and
a cord extending between the body and one of the plurality of branches.

14. The pet toy of claim 13, wherein the filler material includes cat nip.

15. The pet toy of claim 12, further comprising:
a loose toy including a noisemaker,
wherein the base is a bowl including an inner surface defining a cavity, the cavity configured to receive the loose toy.

16. A system comprising:
a wobble toy including a base having a rounded bottom including a plurality of convex protrusions configured to contact a surface supporting the base, a stem extending from the base, and a limb diverging from the stem; and
a hanging toy coupled to the limb.

17. The system of claim 16, further comprising:
a loose toy including a noisemaker,
wherein the base is a bowl including an inner surface defining a cavity, the cavity configured to receive the loose toy.

18. The system of claim 17 wherein the bowl includes a panel disposed above the cavity including at least one aperture configured to receive the loose toy, the stem coupled to and extending from the panel.

19. The system of claim 16, wherein the hanging toy includes:
a body including a compartment;
a filler material disposed within the compartment; and
a cord coupled to the body.

20. The system of claim 19, wherein the filler material includes catnip.
